(19) United States
(12) Patent Application Publication
(10) Pub. No.: US 2021/0382502 A1
(43) Pub. Date: Dec. 9, 2021

(54) AERIAL NAVIGATION SYSTEM

(71) Applicant: Everseen Limited, Blackpool (IE)

(72) Inventors: Alan O'Herlihy, Glenville (IE); Mark Ibbotson, Bentonville, AR (US); Bogdan Ciubotaru, Donoughmore (IE); Razvan-Dorel Cioarga, Oradea (RO); Joe Allen, Ballybunion (IE); Raymond Hegarty, Dublin (IE); Dan Alexandru Pescaru, Timisoara (RO)

(21) Appl. No.: 17/336,481

(22) Filed: Jun. 2, 2021

Related U.S. Application Data
(60) Provisional application No. 63/043,816, filed on Jun. 25, 2020.
(60) Provisional application No. 63/034,155, filed on Jun. 3, 2020.
(60) Provisional application No. 63/034,165, filed on Jun. 3, 2020.

(51) Int. Cl. G05D 1/10; B64C 39/02; B64D 27/24; G08G 5/00; G08G 5/04; B25J 9/12

(52) U.S. Cl. CPC G05D 1/106; B64C 39/02; B25J 9/12; G08G 5/0069; G08G 5/045; B64D 27/24

(57) ABSTRACT

An aerial navigation system comprises upright members mounted with anchor points at a substantially same height. Each anchor point is provided with an electric motor. A carrier device is coupled to the electric motors at corresponding ones of the anchor points using a set of first wires. The carrier device is operably moved by the electric motors in a horizontal plane co-planar with the anchor points. Further, a robotic device is suspended from the carrier device using a second wire. The robotic device is moveable within a volume defined between a ground surface, the plurality of upright members and the horizontal plane by at least one other electric motor mounted on the carrier device. Furthermore, a navigation control system synchronises operations of electric motors at the anchor points and the carrier device for moving the robotic device from a current location to a target location within the volume.

### CROSS-REFERENCE TO RELATED APPLICATION(S)

This application claims priority to and the benefit of U.S. Provisional Application Ser. No. 63/034,155, filed Jun. 3, 2020, U.S. Provisional Application Ser. No. 63/034,165, filed Jun. 3, 2020, and U.S. Provisional Application Ser. No. 63/043,816, filed Jun. 25, 2020, the entire disclosures of which are hereby incorporated by reference.

### TECHNICAL FIELD

This disclosure generally relates to an aerial navigation system having an aerial module and a robotic device therein. More specifically, this disclosure relates to a navigation control system for controlling navigation of the robotic device within a volume of the aerial module.

### BACKGROUND

An unmanned, or uncrewed, aerial vehicle (UAV) commonly known as a drone is an aircraft without a human pilot on board. UAVs are a component of an unmanned aircraft system (UAS), which include the UAV itself, a ground-based controller, and a communication system for facilitating bi-directional communication between the UAV and the ground-based controller. The flight of UAVs may operate with various degrees of autonomy, either under remote control by a human operator or autonomously using onboard sensors and controllers.

Traditional wired aerial robotic devices require manual control of their movements by a trained operator using a joystick apparatus. However, such manual control is an overly labour-intensive process and requires significant motor skills on the part of the human operator.

### SUMMARY

In one aspect of the present disclosure, there is provided an aerial navigation system. The aerial navigation system comprises a plurality of upright members supported on a ground surface. Top portions of the plurality of upright members are mounted with anchor points at a substantially same height from the ground surface. Further, each anchor point is provided with an electric motor. The aerial navigation system also includes a carrier device coupled to the electric motors at corresponding ones of the anchor points using a set of first wires. The carrier device is configured to be operably moved by the electric motors in a horizontal plane co-planar with the anchor points corresponding to the plurality of upright members. Further, the aerial navigation system includes a robotic device suspended from the carrier device using a second wire therebetween. The robotic device is moveable by at least one other electric motor mounted on the carrier device within a volume defined between the ground surface, the plurality of upright members and the horizontal plane. Furthermore, the aerial navigation system includes a navigation control system configured to synchronise the operations of electric motors at the anchor points and the carrier device to permit the robotic device to be moved from a current location to a target location within the volume.

In another aspect of the present disclosure, there is provided a method for making and using an aerial module to control aerial movement of a robotic device therein. The method includes providing a plurality of upright members supported by a ground surface and mounting top portions of the plurality of upright members with anchor points at a substantially same height from the ground surface. The method further includes providing an electric motor and a first wire to each anchor point to operably support movement of a carrier device in a horizontal plane co-planar with the anchor points corresponding to the plurality of upright members. The method further includes suspending the robotic device from the carrier device using a second wire such that the robotic device is moveable within a volume defined between the ground surface and the horizontal plane by at least one other electric motor of the carrier device. The method also includes synchronising operations of electric motors at the anchor points and the carrier device to permit the robotic device to be moved from a current location to a target location within the volume.

In yet another aspect, the present disclosure provides a non-transitory computer readable medium having computer-executable instructions stored thereon. These computer-executable instructions when executed by a processor cause the processor to determine a current location of a robotic device within a volume, calculate a route between the current location and a target location of the robotic device based on depth related obstacle information output by a depth detecting sensor, compute parameters including a number of rotation steps (nrot), a direction of rotation (dir), and a speed of rotation (θ) for the electric motors provided at a plurality of anchor points on a plurality of upright support members and at least one other electric motor of a carrier device moveably connected to the electric motors provided at the plurality of anchor points, and move the robotic device from the current location to the target location within the volume by synchronising operations of the electric motors provided at the anchor points and the carrier device based, at least in part, on the depth related obstacle information and the computed parameters for each of the electric motors.

It will be appreciated that features of the present disclosure are susceptible to being combined in various combinations without departing from the scope of the present disclosure as defined by the appended claims.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1 illustrates an aerial navigation system having an aerial module showing a plurality of upright members, a carrier device and a robotic device successively connected using wires, and a navigation control system for controlling movement of the robotic device, in accordance with an embodiment of the present;

FIG. 2 illustrates a carrier device referential system (CDRS) formed in a horizontal plane of the aerial module, in accordance with an embodiment of the present disclosure;

FIG. 3 illustrates a projection of an exemplary end point in a trajectory of a robotic device in the aerial module, in accordance with an embodiment of the present disclosure;

FIG. 4 illustrates a diagrammatic representation of a three-dimensional control zone of the aerial module of FIG. 1 showing the robotic device operating in relation to an obstacle present within the volume, in accordance with an embodiment of the present disclosure;

FIG. 5 illustrates a view from above the carrier device and the robotic device of FIG. 4; and

FIG. 6 illustrates a method for operating the aerial navigation system to control aerial movement of the robotic device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

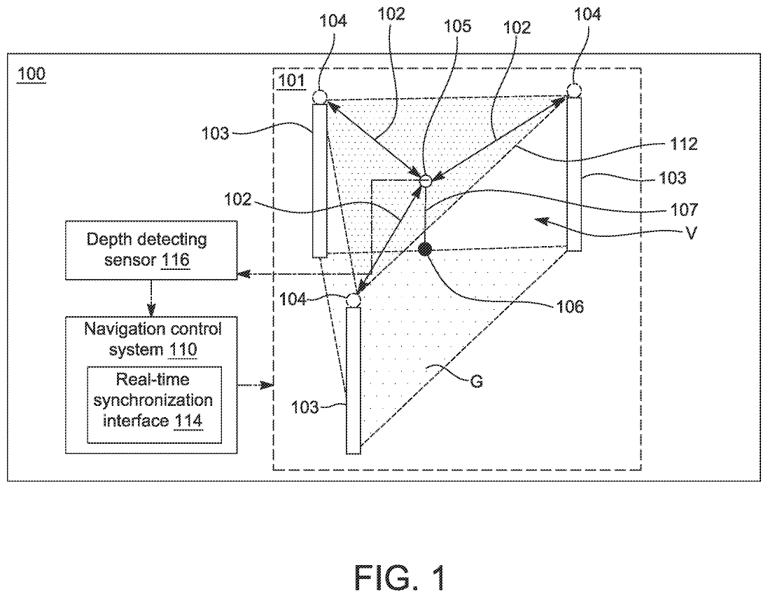

FIG. 1 illustrates an aerial navigation system 100 in accordance with an embodiment of the present disclosure. The aerial navigation system 100 includes an aerial module 101 having a plurality of upright members 103, each of which is supported on a ground surface G (hereinafter referred to as ‘the ground’ and denoted using identical reference ‘G’). To accomplish adequate support, the upright members 103 may, at least partly, be driven into the ground G. Examples of structures that can be used to form the upright member 103 may include, but is not limited to, a wall, a pillar, a pole, or a post. An elevated anchor point 104 is mounted on each upright member 103 at a substantially same height as from the ground G. Each elevated anchor point 104 is provided with an electric motor (not shown) which includes a rotor (not shown). In an example, each of these electric motors may be implemented by use of a direct current (DC) stepper motor.

A carrier device 105 is coupled to the electric motors at corresponding ones of the anchor points 104 using a set of first wires 102 (hereinafter individually referred to as ‘the first wire’ and denoted using identical reference numeral ‘102’). That is, the rotor from each electric motor is coupled with a first end of a corresponding first wire 102 that is arranged so that the rest of the corresponding first wire 102 is at least partly wrapped around the rotor. Moreover, a second end of each first wire 102 from the set of first wires 102 is coupled with the carrier device 105. The carrier device 105 itself houses at least one electric motor (not shown), each of which includes a rotor (not shown). In an example, each of the electric motors associated with the carrier device 105 may be implemented by use of a direct current (DC) stepper motor. The rotor of the carrier device 105 is coupled with a first end of a second wire 107 that is arranged so that the rest of the second wire 107 is at least partly wrapped around the rotor of the carrier device 105. A robotic device 106 is suspended from a second end of the second wire 107. Thus, the set of first wires 102, the upright members 103 and the ground G collectively define a volume V within which the robotic device 106 resides.

The carrier device 105 is adapted to operably move within a bounded horizontal plane 112 defined by the elevated anchor points 104. This movement is achieved through the activation of the electric motors in the anchor points 104 to cause the first wire 102 coupled to each electric motor to be further wound or unwound from the electric motor's rotor, thereby shortening or lengthening each such first wire 102. The robotic device 106 is adapted to move vertically relative to the carrier device 105 through the activation of the electric motor(s) in the carrier device 105 to cause the second wire 107 coupled to each electric motor of the carrier device 105 to be further wound or unwound from the electric motor's rotor, thereby shortening or lengthening the second wire 107.

In an embodiment of the present disclosure, the aerial module 101 is controlled by a navigation control system 110 (hereinafter referred to as ‘the control unit’ and denoted using identical reference numeral ‘110’). The control unit 110 may be implemented as one or more microprocessors, microcomputers, microcontrollers, digital signal processors, logic circuitries, and/or any devices that manipulate data based on one or more instructional codes. The control unit 110 may be implemented as a combination of hardware and software, for example, programmable instructions that are consistent with implementation of one or more functionalities disclosed herein.

In an embodiment of the present disclosure, the control unit 110 may be configured to determine a current location of the robotic device 106 within the volume V. The control unit 110 is further configured to synchronise the operations of the electric motors in the elevated anchor points 104 and the carrier device 105 to permit the robotic device 106 to be moved from its current location to a target location within the volume V, without the necessity of human intervention. In an embodiment of the present disclosure, the control unit 110 is configured to calculate a route between the current and target locations of the robotic device 106.

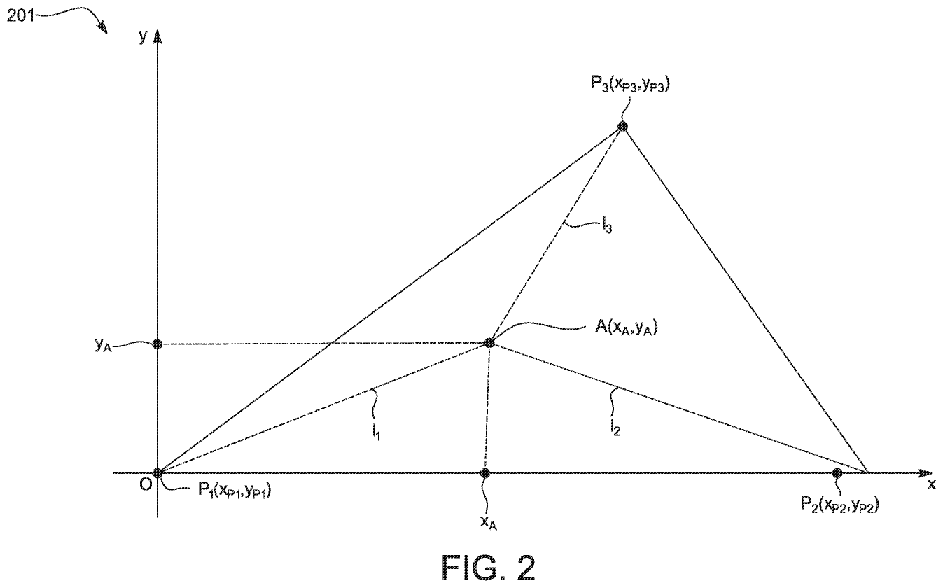

FIG. 2 illustrates a carrier device referential system (CDRS) 201 formed in the horizontal plane 112 defined by the three electric motors (housed in the elevated anchor points 104).

With combined reference to FIGS. 1 and 2, in an embodiment, the CDRS 201 is a triangular 2D projection of the volume V onto the horizontal plane 112. As such, in an embodiment as best shown in the view of FIG. 1, the volume V defined between the upright members 103, the ground G and the horizontal plane 112 is a prismatic volume. The CDRS 201 comprises three vertices P1, P2 and P3, wherein the first vertex P1 corresponds to the intersection of the horizontal plane 112 with a first one of the upright members 103, the second vertex P2 corresponds to the intersection of the horizontal plane 112 with a second one of the upright members 103, and the third vertex P3 corresponds to the intersection of the horizontal plane 112 with a third one of the upright members 103.

Within the CDRS 201, the position of each of P1, P2 and P3 is denoted by (x_{P1}, y_{P1}), (x_{P2}, y_{P2}) and (x_{P3}, y_{P3}) respectively. The first vertex P1 is defined to be the origin of the CDRS 201. Thus, x_{P1}=0 and y_{P1}=0. From this, it can also be inferred that y_{P2}=0. The remaining co-ordinates of the second and third vertices P2 and P3 are computed based on the known distances {d_{P1P2}, d_{P1P3}, d_{P2P3}} between the upright members 103 where d_{P1P2} is the distance between the vertices P1 and P2, d_{P2P3} is the distance between the vertices P2 and P3, and d_{P1P3} is the distance between the vertices P1 and P3. More specifically,

$${x}_{P 2} = {d}_{P 1 P 2} \\ {x}_{{p}_{3}} = \frac{{d}_{P 1 P 3}^{2} + {d}_{P 1 P 2}^{2} - {d}_{P 2 P 3}^{2}}{2 {d}_{P 1 P 2}} \\ {y}_{{P}_{3}} = \sqrt{{d}_{P 1 P 3}^{2} - {x}_{P 3}^{2}} .$$

Referring back to FIG. 1, as the volume V is defined by the relative arrangement of the first wires 102 in the horizontal plane 112, the upright members 103 and the ground G, the location of the robotic device 106 within the volume V is defined by:
(a) the coordinates of the carrier device 105 in the horizontal plane 112 defined by the elevated anchor points 104; and
(b) the distance between the carrier device 105 and the robotic device 106, denoted by the unwound length of the second wire 107 (thereby representing the vertical penetration of the robotic device 106 into the volume V).

More specifically, the co-ordinates of the carrier device 105 in the horizontal plane 112 is determined by the lengths of individual ones of the first wires 102 coupling the carrier device 105 to corresponding ones of the elevated anchor points 104. Thus, referring to the CRDS 201 shown in FIG. 2, a current location of the robotic device 106 within the volume V corresponds to a start point A of the trajectory of the carrier device 105 in the horizontal plane 112. The start point A is connected to the vertices P1, P2 and P3 by line segments of length l₁, l₂ and l₃ respectively, where these lengths of these line segments are indicative of, and hence correspond with, the lengths of the first wires 102 connecting the carrier device 105 to the elevated anchor points 104.

From the above formulation for the CDRS 201, the lengths (l₁ and l₂) of the line segments connecting the start point A of the carrier device 105 to the vertices P1 and P2 can be expressed as follows:

l₁²=x_{A}²+y_{A}² (1)

l₂²=(x_{P2}−x_{A})²+y_{A}² (2)

Combining these two expressions (1) and (2), the co-ordinates (x_{A}, y_{A}) of the start point A can be established as follows:

$$\begin{matrix}{l}_{1}^{2} - {l}_{2}^{2} = {x}_{A}^{2} - {( {x}_{P 2} - {x}_{A} )}^{2} & ( 3 ) \\ 2 {x}_{A} {x}_{P 2} = ( {l}_{1}^{2} - {l}_{2}^{2} ) + {{x}_{P 2}}^{2} & ( 4 ) \\ {x}_{A} = \frac{( {l}_{1}^{2} - {l}_{2}^{2} ) + {{x}_{P 2}}^{2}}{2 {x}_{P 2}} & ( 5 ) \\ {y}_{A} = \sqrt{{l}_{1}^{2} - {x}_{A}^{2}} & ( 6 )\end{matrix}$$

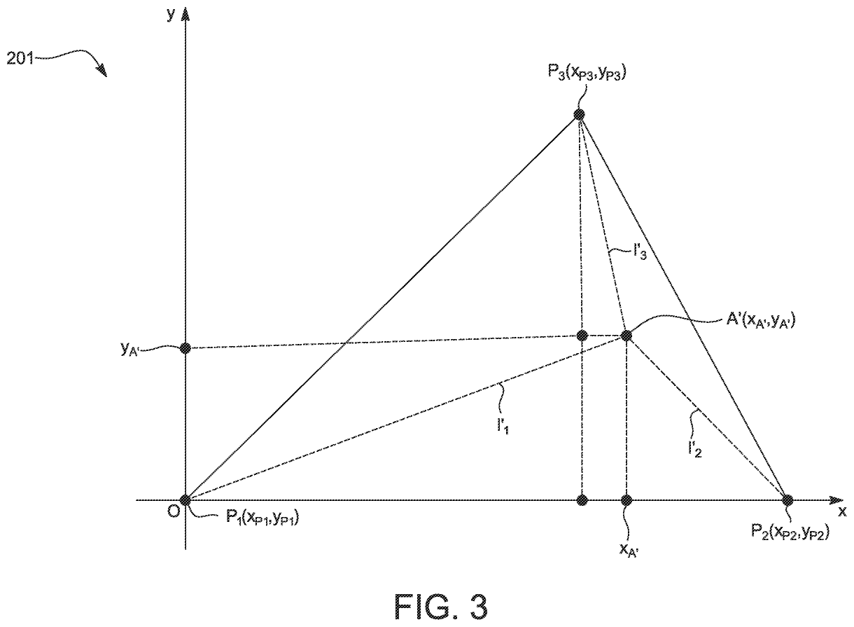

With combined reference to FIGS. 1 and 3, the projection of the target location of the robotic device 106 into the horizontal plane 112 is a point A′ with coordinates (x_{A′}, y_{A′}). Accordingly, the target location of the robotic device 106 within the volume V corresponds with the end point A′ from the trajectory of the carrier device 105 along the horizontal plane 112. In an analogous fashion to the above derivation of the coordinates corresponding to a current location A of the carrier device 105, the coordinates of the end point A′ can also be defined in terms of the lengths l′₁, l′₂, l′₃ of the individual first wires 102 that would be needed to position the carrier device 105 at the end point A′ corresponding to the target location of the robotic device 106. In other words, using the above formulation for the CDRS 201, l′₁, l′₂, l′₃ are the lengths of the line segments connecting the point A′ to the vertices P1, P2 and P3 of the CDRS 201. The lengths l′₁, l′₂, l′₃ are determined as follows:

$$\begin{matrix}{{l}^{′}}_{1} = \sqrt{{x}_{{A}^{′}}^{2} + {y}_{{A}^{′}}^{2}} & ( 7 ) \\ {{l}^{′}}_{2} = \sqrt{{( {x}_{{P}_{2}} - {x}_{{A}^{′}} )}^{2} + {y}_{{A}^{′}}^{2}} & ( 8 ) \\ {{l}^{′}}_{3} = \sqrt{{( {x}_{{A}^{′}} - {x}_{{P}_{3}} )}^{2} + {( {y}_{{P}_{3}} - {y}_{{A}^{′}} )}^{2}} & ( 9 )\end{matrix}$$

Referring back to FIG. 1, to move the carrier device 105 from the start point A to the end point A′, the aerial module 101 may include a local computing device (not shown) for facilitating bi-directional communication between the control unit 110 and the electric motors located at each of the anchor points 104 and the carrier device 105. For instance, the electric motor at the anchor point 104 of each upright member 103 may be provided with a local computing device that controls the electric motors located at corresponding ones of the anchor points 104. Each of the local computing devices may be implemented with a real-time operating system and low-level device drivers to control corresponding ones of the electric motors.

In an embodiment of the present disclosure, the control unit 110 is configured to implement a navigation algorithm to compute parameters for each electric motor to cause movement of the carrier device 105 along the route, or trajectory, from the start point A to the end point A′ in the CDRS 201 as shown in the views of FIGS. 2 and 3 respectively. These parameters are specific for each electric motor i, i∈{1,2,3} and represent:
Number of rotation steps (nrotᵢ) needed for an electric motor i to wind/unwind its corresponding first wire 102 by a required length where the electric motor acts as a spool with its axle arranged so that it winds/unwinds k cm of wire (e.g. k=0.01 m) with each complete rotation.

$$n r o {t}_{i} = \frac{\vert {l}_{i} - {{l}^{′}}_{i} \vert}{k} \qquad ( 10 )$$

Direction of rotation (dirᵢ): It is hereby envisioned that, in use, the electric motor i winds or unwinds its corresponding first wire 102 by the length (l′ᵢ) needed to move the carrier device 105 from the start point A to the end-point A′ as detailed above. The rotation direction needed for such winding/unwinding operation is described as +1 for clockwise rotation and −1 for anticlockwise rotation. Therefore, dirᵢ is computed using the following equation:

dirᵢ=sign(lᵢ−l′ᵢ) (11)
Speed of rotation θᵢ: It is hereby further envisioned that in order to move the carrier device 105 from the start point A to the end point A′ within a certain amount of time, all the electric motors must wind/unwind their respective lengths of the first wire 102 within the same amount of time. Thus, each electric motor must be capable of operating at different speeds from the others. More specifically, to move the carrier device 105 at a predefined speed of ξ m/s (e.g. ξ=0.1 m/s), the rotational speed θᵢ of each electric motor (expressed as the number of rotations performed per second) is given by the following equations:

$${θ}_{i} = \frac{n r o {t}_{i}}{{t}_{n a v}} \qquad ( 12 )$$

where

$${t}_{n a v} = \frac{\sqrt{{( {x}_{{A}^{′}} - {x}_{A} )}^{2} + {( {y}_{{A}^{′}} - {y}_{A} )}^{2}}}{ξ} \qquad ( 13 )$$

Each local computing device may be provided with a buffer. Using the above equations, the control unit 110 may calculate the movement parameters (nrotᵢ, dirᵢ and θᵢ) for each electric motor and communicate the movement parameters for a given electric motor to the local computing device associated therewith. The local computing device stores the movement parameters (nrotᵢ, dirᵢ and θᵢ) in its buffer.

In an embodiment of the present disclosure, synchronisation of movements of all electric motors is achieved through their connection through a real-time synchronization interface such as, for example, with use of an EtherCAT microchip to allow the carrier device 105 to be moved at a pre-defined speed ξ (e.g. ξ=0.1 m/s). The pre-defined speed and direction of travel computed by the control unit 110 for the robotic device 106 may take into account a balance, for instance, a trade-off between one or more imperatives including, but not limited to, reducing travel time considering the constraints imposed by the physical limitations of the aerial module 101 or executing smooth starting and stopping of the robotic device 106 whilst ensuring safe movement of the robotic device 106 within the volume of the aerial module 101.

For sake of simplicity in this disclosure, referring to FIG. 1, the carrier device 105 is shown adapted to move within the bounded horizontal plane 112. The movement of the carrier device 112 is achieved by varying the length i.e., through the lengthening or shortening of at least two first wires 102 from the set of first wires 102 that connect the carrier device 112 to the elevated anchor points 104. Thus, referring to FIGS. 2 and 3, the carrier device 105 is shown to move in either, or both, the x and y directions of the CDRS 201. Moreover, as each local computing device is synchronized through the shared real-time synchronization interface 114 of the control unit 110 to ensure simultaneous yet independent control and operation of the respective electric motors, it is to be understood that the set of first wires 102 moveably connecting each anchor point 104 to the carrier device 105 is maintained taut by mutually optimized speeds, directions and numbers of rotation executed by corresponding ones of the electric motors via the computed parameters (nrotᵢ, dirᵢ and θᵢ). However, it is hereby contemplated that in alternative embodiments of the present disclosure, the set of first wires 102 may not be taut, rather, the carrier device 105 may be partially suspended in relation to the horizontal plane 112 using pre-computed slack willfully, or deliberately, imparted to one or more of the first wires 102, as computed by the control unit 110 depending upon specific requirements of an application.

With further execution of the navigation algorithm, the system's movements are expanded from the horizontal plane 112 to the volume V. Specifically, the robotic device 106 is lowered/raised from its current altitude H_{CD} to a target height z_{T} (being the altitude of the of the robotic device 106 at the target location corresponding to the end point A′ indicated in the CDRS 201 of FIG. 3). This is achieved using the electric motor which controls the second wire 107 that links the carrier device 105 and the robotic device 106. The movement parameters (nrot_{RD}, dir_{RD}, and θ_{RD}) for this electric motor are determined using the equations below.

$$\begin{matrix}n r o {t}_{R D} = \frac{\vert {H}_{C D} - {z}_{T} \vert}{k} & ( 14 ) \\ di {r}_{R D} = sign ( {H}_{C D} - {z}_{T} ) & ( 15 ) \\ {θ}_{RD} = \frac{{nrot}_{RD}}{{t}_{hi\_lo}} ; where & ( 16 ) \\ {t}_{hi\_lo} = \frac{\vert {H}_{C D} - {z}_{T} \vert}{ξ} & ( 17 )\end{matrix}$$

In an embodiment of the present disclosure, equipped with this formulation, a closed loop control system (including for example, model-based predictive control mechanisms) may be implemented to adapt the movement parameters in real time to confirm with curvilinear kinematics. Such adaptation would allow the robotic device 106 to autonomously implement 3D curvilinear trajectories including spiral, conchoid, helical and hemispherical flight paths. Furthermore, the above formulation supports adaptive control of velocity during different stages of the curvilinear trajectory, such that the robotic device 106 accelerates/decelerates to different velocities at different stages of the curvilinear trajectory. These features would enable the aerial module 101 to be implemented for use in enhanced autonomous reconnaissance and surveillance applications. Example use cases may include, but are not limited to, detailed sweep-in views of a surveyed scene, adaptive top down and side-ways views of stacked or tall items (for example, pallets in a warehouse facility), or items partially obscured by one or more obstacles, and tracking of subjects moving in a curvilinear path.

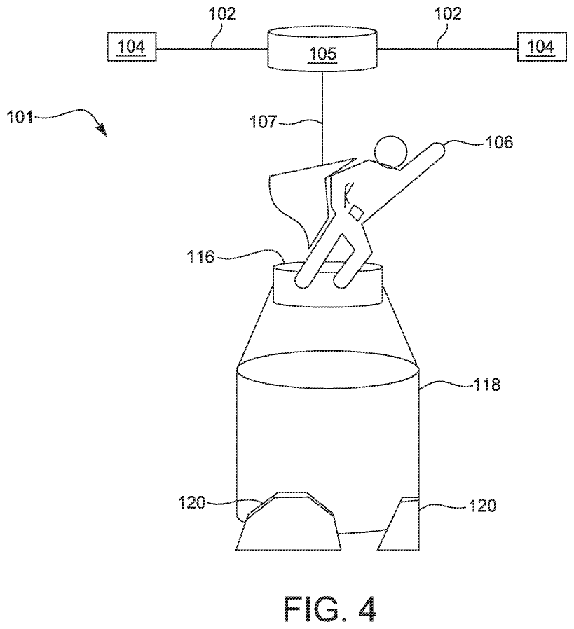

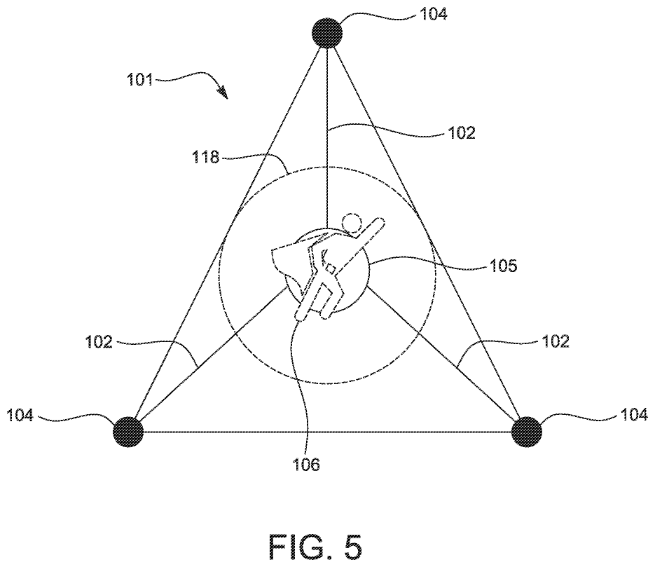

FIG. 4 diagrammatically illustrates a three-dimensional control zone of the aerial module 101 of FIG. 1 operating in relation to an obstacle present within the volume V. FIG. 5 illustrates a view from above the carrier device 105 and the robotic device 106 of FIG. 4.

Referring to FIGS. 4 and 5, the aerial module 101 comprises a plurality of upright members (not shown) and corresponding elevated anchor points 104 as previously described herein. Each elevated anchor point 104 comprises an electric motor (not shown) which in turn includes a rotor (not shown). Each rotor is coupled with a first end of the first wire 102 which is arranged so that the rest of the first wire 102 is at least partly wrapped around the rotor (not shown). The second end of each first wire 102 is coupled with the carrier device 105. The carrier device 105 itself houses at least one electric motor (not shown), each of which includes a rotor (not shown). The rotor of the carrier device 105 is coupled with a first end of the second wire 107 which is arranged so that the rest of the second wire 107 is at least partly wrapped around the rotor in the electric motor of the carrier device 105. The robotic device 106 is suspended from the second end of the second wire 107.

As previously described herein, the carrier device 105 is adapted to move within the bounded horizontal plane 112 defined by the elevated anchor points 104. This movement is achieved through the activation of the electric motors in the anchor points 104 to cause the first wire 102 coupled to each electric motor to be further wound or unwound from the electric motor's rotor, thereby shortening or lengthening each such first wire 102. The robotic device 106 is adapted to move vertically relative to the carrier device 105 through the activation of the electric motor(s) in the carrier device 105 to cause the second wire 107 coupled to each electric motor to be further wound or unwound from the electric motor's rotor, thereby shortening or lengthening the second wire 107.

Also, as shown best in the views of FIGS. 1 and 4, the aerial module 101 may further contain a depth detecting sensor 116, which may include, for example, a radar or an RGB-Depth sensor. In use, the depth detecting sensor 116 is mounted on the robotic device 106 in a downwards-facing configuration. In particular, the depth detecting sensor 116 is arranged to detect the presence of one or more items 120 beneath the robotic device 106 and determine the difference in elevation between the robotic device 106 and the detected items 120. Depending on the elevation of the detected items 120 relative to the robotic device 106, the detected items may be considered potential obstacles by the control unit 110 to the movement of the robotic device 106. Combining the field of view of the depth detecting sensor 116 with the relative elevations of items 120 detected within the field of view, a safe volume 118 may be established along a given trajectory/route by the control unit 110. The safe volume 118 is disposed above, or around a maximum width of, the detected items 120 and configured to provide a clearance to the trajectory for movement of the robotic device 106 relative to the detected items 120. Accordingly, the safe volume 118 represents a region within which the robotic device 106 may move without risk of collision with items 120 located beneath, or around, the robotic device 106.

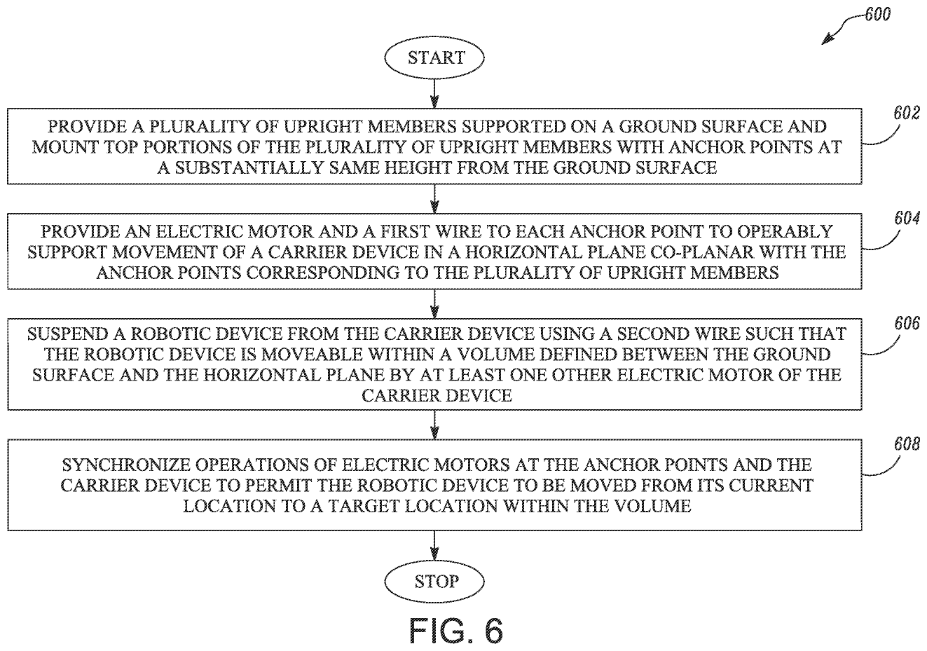

FIG. 6 illustrates a method 600 for operating the aerial navigation system 100, as shown in FIG. 1, to control aerial movement of the robotic device 107 in accordance with an embodiment of the present disclosure.

As shown, at step 602, the method 600 includes providing the plurality of upright members 103 supported by the ground surface G and mounting top portions of the plurality of upright members 103 with anchor points 104 at a substantially same height from the ground surface G.

At step 604, the method 600 further includes providing the electric motor and the first wire 102 to each anchor point 104 to operably support movement of the carrier device 105 in the horizontal plane 112 co-planar with the anchor points 104 corresponding to the plurality of upright members 103.

At step 606, the method 600 further includes suspending the robotic device 106 from the carrier device 105 using the second wire 107 such that the robotic device 106 is moveable within the volume V defined between the ground surface G and the horizontal plane 112 by at least one other electric motor of the carrier device 105.

At step 608, the method 600 includes synchronising operations of electric motors at the anchor points 104 and the carrier device 105 to permit the robotic device 106 to be moved from its current location to the target location within the volume V.

In an embodiment, the method 600 includes computing parameters for each electric motor at respective anchor points 104 to cause movement of the carrier device 105 from the start point A to the end point A′ in the horizontal plane 112 in which the movement of the carrier device 105 is achieved by varying a length of at least two wires 102 from the set of first wires 102. Further, in this embodiment, the method 600 also includes computing parameters for the at least one other electric motor at the carrier device 105 to cause the robotic device 106 to vertically move from its current altitude H_{CD} to the target height z_{T}. As disclosed earlier herein, the target height z_{T} is an altitude of the robotic device 106 at the target location corresponding to the end point A′ of the carrier device 105 in the horizontal plane 112. The movement of the robotic device 106 is achieved by varying a length of the second wire 107.

In an embodiment, the method 600 includes determining the current location of the robotic device 106 within the volume V, and calculating a route between the current location and the target location of the robotic device 106. The method 600 further includes calculating, by the navigation control system 110, the route for the robotic device 106 based on depth related obstacle information output by the depth detecting sensor 116 with the depth detecting sensor 116 being positioned on the robotic device 106.

In an embodiment, the method 600 further includes computing at least three parameters for the movement of the robotic device 106 within the volume V, and wherein the at least three parameters include the number of rotation steps (nrot), the direction of rotation (dir), and the speed of rotation (θ) for each electric motor. Further, the method 600 also includes moving the carrier device 105 at a pre-defined speed and direction within the volume V by synchronizing individual movements of the electric motors in real-time based on the at least three computed parameters.

It is hereby contemplated that functions consistent with the present disclosure can be embodied as one or more computer-executable software instructions or code that may be stored on a non-transitory computer readable medium. It should be noted that the control unit 110 of the present disclosure may also include one or more processors, micro-processors, controllers, micro-controllers, actuators and the like to individually, or collectively, control operation of the various electric motors in a manner consistent with the present disclosure. These processors, micro-processors, controllers, micro-controllers, actuators and the like may be readily embodied in the form of general purpose computers or application specific controllers that can be readily implemented for use in facilitating operation of the control unit 110 disclosed herein. These software instructions when executed by a processor of the control unit 110 can cause the processor to determine the current location of the robotic device 106 within the volume V, calculate the route between the current location and the target location of the robotic device 106, and synchronise operations of the electric motors at the anchor points 104 of the upright support members 103 and the carrier device 105 for moving the robotic device 106 from its current location to the target location within the volume V.

Various embodiments of the present disclosure relates to a method of determining the location of an aerial module within a volume defined by the elevated anchor points and the ground underneath. When equipped with this information, the invention includes a method and a non-transitory computer readable media for automatically controlling the movement of the aerial module so that it is navigated from its current location to a target location within the defined volume. In this way, the invention at least partly obviates the need for human intervention i.e., manual effort previously incurred in the control of movement, both—direction and speed of the robotic device to the target i.e., desired, or required, location within the volume of the aerial module.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. An aerial navigation system comprising:
a plurality of upright members supported on a ground surface, wherein top portions of the plurality of upright members are mounted with anchor points at a substantially same height from the ground surface, and wherein each anchor point is provided with an electric motor;
a carrier device coupled to the electric motors at corresponding ones of the anchor points using a set of first wires, wherein the carrier device is configured to be operably moved by the electric motors in a horizontal plane co-planar with the anchor points corresponding to the plurality of upright members;
a robotic device suspended from the carrier device using a second wire therebetween, the robotic device moveable by at least one other electric motor mounted on the carrier device, within a volume defined between the ground surface, the plurality of upright members and the horizontal plane; and
a navigation control system configured to synchronise operations of the electric motors at the anchor points and the carrier device to permit the robotic device to be moved from a current location to a target location within the volume.

2. The aerial navigation system of claim 1, wherein the navigation control system is further configured to compute parameters for:
each electric motor at respective anchor points to cause movement of the carrier device from a start point to an end point in the horizontal plane, wherein the movement of the carrier device is achieved by varying a length of at least two wires from the set of first wires; and
the at least one other electric motor at the carrier device to cause the robotic device to vertically move from a current altitude to a target height, wherein the target height is an altitude of the robotic device at the target location corresponding to the end point of the carrier device in the horizontal plane, wherein the movement of the robotic device is achieved by varying a length of the second wire.

3. The aerial navigation system of claim 2, wherein the computed parameters include a number of rotation steps (nrot), a direction of rotation (dir), and a speed of rotation (θ) for each electric motor at the anchor points and the at least one other electric motor at the carrier device respectively.

4. The aerial navigation system of claim 3, wherein the navigation control system includes a real-time synchronization interface that controls individual movements of the electric motors independently of one another based on the computed parameters for permitting the carrier device to be moved at a pre-defined speed and direction within the volume.

5. The aerial navigation system of claim 1, wherein the plurality of upright members includes three upright members.

6. The aerial navigation system of claim 1, wherein the volume defined between the ground surface and the horizontal plane subtended by the anchor points corresponding to the plurality of upright members is a prismatic volume.

7. The aerial navigation system of claim 1, wherein the navigation control system is further configured to:
determine the current location of the robotic device within the volume; and
calculate a route between the current location and the target location of the robotic device.

8. The aerial navigation system of claim 7 further comprising a depth detecting sensor positioned on the robotic device, wherein the depth detecting sensor is configured to:
detect one or more obstacles present in the volume; and
determine a difference in elevation between the robotic device and the detected obstacles; and
output depth related obstacle information to the navigation control system based on the determined elevation difference.

9. The aerial navigation system of claim 8, wherein the navigation control system is configured to calculate the route based on depth related obstacle information outputted by the depth detecting sensor.

10. The aerial navigation system of claim 8, wherein the depth detecting sensor includes one of a radar and an RGB-Depth sensor.

11. The aerial navigation system of claim 1, wherein the navigation control system is configured to locate the robotic device within the volume using a) coordinates of the carrier device referenced against the anchor points, and b) a distance between the carrier device and the robotic device.

12. The aerial navigation system of claim 1, wherein co-ordinates of the carrier device are determined, in part, based on lengths of individual wires from the set of first wires coupling the carrier device to respective electric motors at the anchor points.

13. The aerial navigation system of claim 1 further comprising a local computing device for bi-directional communication between the navigation control system and the electric motors located at each of the anchor points and the carrier device.

14. A method for operating an aerial navigation system to control aerial movement of a robotic device therein, the method comprising:
providing a plurality of upright members supported by a ground surface and mounting top portions of the plurality of upright members with anchor points at a substantially same height from the ground surface;
providing an electric motor and a first wire to each anchor point to operably support movement of a carrier device in a horizontal plane co-planar with the anchor points corresponding to the plurality of upright members;
suspending the robotic device from the carrier device using a second wire such that the robotic device is moveable within a volume defined between the ground surface and the horizontal plane by at least one other electric motor of the carrier device; and
synchronising operations of the electric motors at the anchor points and the carrier device to permit the robotic device to be moved from a current location to a target location within the volume.

15. The method of claim 14 further comprising computing parameters for:
each electric motor at respective anchor points to cause movement of the carrier device from a start point to an end point in the horizontal plane, wherein the movement of the carrier device is achieved by varying a length of at least two wires from the first wires; and
the at least one other electric motor at the carrier device to cause the robotic device to vertically move from a current altitude to a target height, wherein the target height is an altitude of the robotic device at the target location corresponding to the end point of the carrier device in the horizontal plane, wherein the movement of the robotic device is achieved by varying a length of the second wire.

16. The method of claim 14 further comprising:
determining the current location of the robotic device within the volume; and
calculating a route between the current location and the target location of the robotic device.

17. The method of claim 16 further comprising calculating the route based on depth related obstacle information output by a depth detecting sensor, and wherein the depth detecting sensor is positioned on the robotic device.

18. The method of claim 14 further comprising computing at least three parameters for the movement of the robotic device within the volume, and wherein the at least three parameters include a number of rotation steps (nrot), a direction of rotation (dir), and a speed of rotation (θ) for each electric motor.

19. The method of claim 18 further comprising moving the carrier device at a pre-defined speed and direction within the volume by synchronizing individual movements of the electric motors in real-time based on the at least three computed parameters.

20. A non-transitory computer readable medium having stored thereon computer-executable instructions which, when executed by a processor, cause the processor to:
determine a current location of a robotic device within a volume;
calculate a route between the current location of the robotic device and a target location based on depth related obstacle information output by a depth detecting sensor;
compute parameters including a number of rotation steps (nrot), a direction of rotation (dir), and a speed of rotation (θ) for a plurality of electric motors provided at a plurality of anchor points on a plurality of upright support members and at least one other electric motor of a carrier device moveably connected to the electric motors provided at the plurality of anchor points; and
move the robotic device from the current location to the target location within the volume by synchronising operations of the electric motors provided at the anchor points and the carrier device based, at least in part, on the depth related obstacle information and the computed parameters for each of the electric motors.
